(19) United States
(12) Patent Application Publication
(10) Pub. No.: US 2021/0248667 A1
(43) Pub. Date: Aug. 12, 2021

(54) GIFT-TRANSFER SYSTEM

(71) Applicant: HALLMARK CARDS, INCORPORATED, KANSAS CITY, MO (US)

(72) Inventors: SCOTT A. SCHIMKE, LEAVENWORTH, KS (US); JENNIFER R. GARBOS, KANSAS CITY, MO (US)

(21) Appl. No.: 17/180,273

(22) Filed: Feb. 19, 2021

Related U.S. Application Data
(62) Division of application No. 15/791,576, filed on Oct. 24, 2017, now abandoned.
Application No. 15/791,576 is a continuation-in-part of application No. 15/227,779, filed on Aug. 3, 2016, now abandoned.

(51) Int. Cl. G06Q 30/06; B42D 15/04; B41M 7/00; G06Q 20/30; H04W 4/60; H04L 29/08; G06Q 20/34; G06Q 20/32

(52) U.S. Cl. CPC G06Q 30/0641; B42D 15/04; B41M 7/0027; G06Q 20/30; G06Q 20/352; H04L 67/02; G06Q 20/3567; G06Q 20/3278; H04W 4/60

(57) ABSTRACT

An aspect of the present invention includes a method for transferring a gift using a gift-transfer application. A digital gift can be associated with a unique tag identifier on a gift item, and the unique tag identifier can be used to retrieve the digital gift. Specifically, the method includes associating the unique tag identifier with an electronic gift of a particular monetary value and using a payment portal to charge a financial account an amount equal to the monetary value. The method further includes the gift-transfer application receiving a request including the unique tag identifier to redeem the electronic gift and, in response, sending a plurality of value-allocation links along with respective options for applying the monetary value to an electronic gift card of a respective merchant.

### CROSS-REFERENCE TO RELATED APPLICATIONS

This application is a divisional, non-provisional patent application of U.S. patent application Ser. No. 15/791,576, filed Oct. 24, 2017, which was a continuation-in-part of U.S. patent application Ser. No. 15/227,779, filed Aug. 3, 2016. Both applications are hereby incorporated herein by reference in their entirety.

### TECHNICAL FIELD

This disclosure relates to a system for electronically transferring a digital gift.

### BACKGROUND

Sometimes people choose to give money as a gift to another person, such as by giving the person cash, a check, or a gift card. But, these options can be less personal than a greeting card or other gift item.

### SUMMARY

An aspect of the present invention includes transferring a digital gift (e.g., electronic funds, digital media, etc.). Among other things, a gift sender may associate the digital gift with a unique identifier, which is included as part of a physical gift item. The unique identifier may be communicated to the gift recipient, such as by transferring the physical gift item to the gift recipient. The gift recipient may then use the unique identifier to retrieve the digital gift.

Some aspects of the invention are defined by the claims below, not this summary. A high-level overview of various aspects of the invention is provided here to introduce a selection of concepts that are further described below in the detailed-description section. This summary is not intended to identify key or essential features of the claimed subject matter, nor is it intended to be used as an aid in isolation to determine the scope of the claimed subject matter.

### BRIEF DESCRIPTION OF THE DRAWINGS

Illustrative embodiments of the present invention are described in detail in the Detailed Description section, and reference is made to the figures filed together with this Specification. The figures are incorporated herein by reference, and a brief description of each figure is provided directly below.

FIG. 1 depicts an illustrative environment in which some aspects of the present invention may be carried out or practiced in accordance with an embodiment of the present invention.

FIGS. 2A and 2B depict exemplary greeting cards that are constructed to include NFC tags in accordance with some embodiments of the present invention.

FIGS. 2C-2F and 2I-2J each depicts an exemplary variety of greeting card that is constructed to include a tag in accordance with an embodiment of the present invention.

FIGS. 2G and 2H each depicts an exemplary variety of tag that might be affixed to a physical gift item in accordance with embodiments of the present invention.

FIG. 3 depicts another type of physical gift item in accordance with an embodiment of the present invention.

FIG. 4 depicts a computing device running a gift-transfer software application in accordance with an embodiment of the present invention.

FIGS. 5A-5C depict respective components of the gift-transfer software application in accordance with some embodiments of the present invention.

FIG. 6 depicts some components of a gift-transfer service in accordance with an embodiment of the present invention.

FIG. 7 depicts a schematic ping diagram illustrating interaction between various components in accordance with an embodiment of the present invention.

FIG. 8 depicts a generic computing device in accordance with an aspect of the present invention.

### DETAILED DESCRIPTION

The subject matter of this disclosure is described with specificity herein to meet statutory requirements. But, the description itself is not intended to necessarily limit the scope of claims. Rather, the claimed subject matter might be embodied in other ways to include different elements or combinations of elements similar to the ones described in this document, in conjunction with other present, or future, technologies. Terms should not be interpreted as implying any particular order among or between various steps herein disclosed unless, and except, when the order of individual steps is explicitly claimed.

At a high level, this disclosure describes a system that allows a person (“gift sender”) to electronically transfer a digital gift (also sometimes referred to as an “e-gift”) to another person (“gift recipient”). A digital gift may take various forms, and some examples of digital gifts include electronic funds (e.g., deposited to an account) or a digital experience (e.g., e-card, digital video, digital audio, digital image, etc.). Generally, in accordance with an embodiment, the gift sender uses a gift-transfer application (e.g., website or mobile application) to associate the digital gift with a unique identifier, and the digital gift is stored by a gift-transfer service. The unique identifier is communicated to the gift recipient, who can use the gift-transfer application to retrieve the digital gift from the gift-transfer service using the unique identifier.

The unique identifier might be tagged onto a physical gift item (e.g., greeting card, toy, and the like) in various manners. For example, the unique identifier might be marked (e.g., printed, etched, embossed, etc.) directly on the physical gift item or onto a sheet of material that is affixed to the physical gift item, and the gift sender and gift recipient might ascertain (e.g., read) the unique identifier from the marking on the physical gift item or on the sheet of material. In another instance, the unique tag identifier might be stored in a near-field-communication tag (NFC tag) constructed into the physical gift item, and the gift sender and gift recipient may use a computing device to read the unique tag identifier. As such, in this disclosure, a “unique tag identifier” describes an identifier that uniquely identifies a tag that may be affixed to a gift item. Examples of unique tag identifiers include a series of number, letters, symbols, and any combination thereof. A “tag” includes a marking of a unique identifier directly on a gift item or an article that may be affixed to a gift item for the purpose of affixing the unique identifier to the gift item. Examples of tags include a marking (e.g., printing, etching, embossing, etc.) applied directly to a physical gift item, a sheet of material (e.g., paper, cardstock, adhesive label, etc.), and an NFC tag.

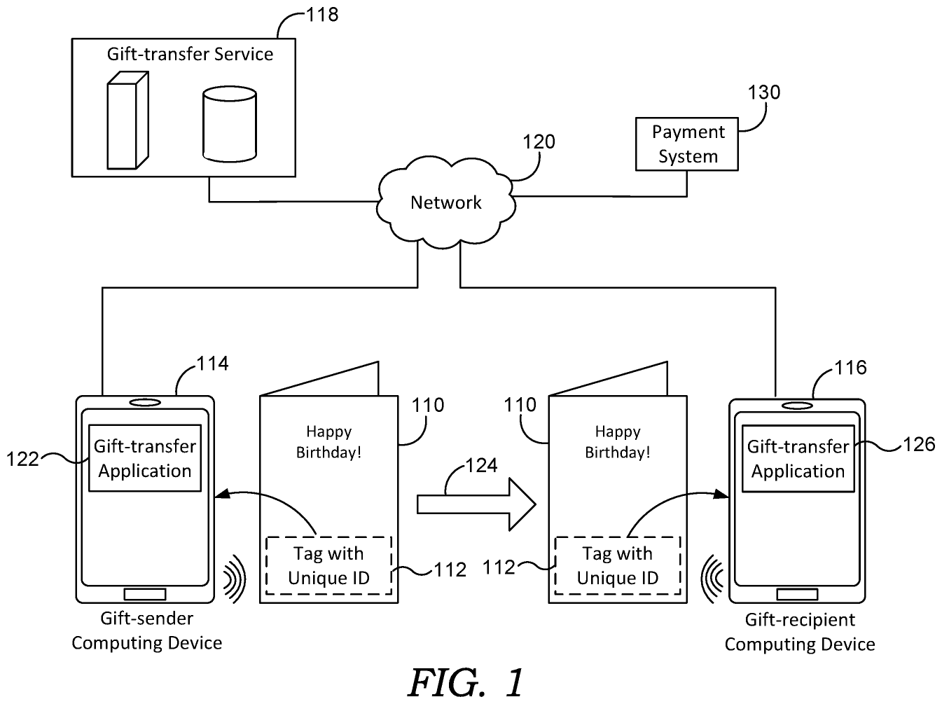

Referring now to FIG. 1, an illustrative environment is depicted in which various aspects of this disclosure may be practiced or carried out. As can be seen, FIG. 1 includes a physical gift item 110 that is constructed to include a tag 112. For example, the tag 112 may be an NFC tag, which includes a unique NFC-tag identifier; or the tag 112 may include a sheet of material that is affixed to the physical gift item 110 and that is marked with a unique tag identifier; or the tag 112 may include a marking of the unique tag identifier directly on the physical gift item 110. In addition, FIG. 1 depicts a gift-sender computing device 114, a gift-recipient computing device 116, and a gift-transfer service 118 that communicates with the computing devices 114 and 116 by way of a network 120 (e.g., PAN, WAN, LAN, MAN, and the like). FIG. 1 also depicts a payment system 130 that helps facilitate payment for a digital gift transferred from the gift sender to the gift recipient.

In accordance with an aspect of the disclosure, the unique tag identifier is communicated to the gift-sender computing device 114. For example, if the tag 112 is an NFC tag, then the gift-sender computing device 114 may scan the NFC tag to receive both the unique NFC-tag identifier and computer-executable instructions for opening a first gift-transfer application 122. In an alternative aspect, in which the unique identifier is marked on the gift item or on a tag affixed to the gift item, the unique tag identifier may be manually input by the gift sender into the gift-transfer application, which may include a mobile application or a web application. The gift-transfer application 122 can be used to associate a digital gift with the unique tag identifier and to communicate the association to the gift-transfer service 118. The gift-transfer service 118 stores a record of the association between the unique tag identifier and the digital gift, and the payment system 130 facilitates payment for the digital gift by an account specified using the first gift-transfer application 122.

The physical gift item 110, which includes the tag 112, can be given to a gift recipient, as illustratively depicted by an arrow 124. The unique tag identifier can then be communicated to the gift-recipient computing device 116. For example, if the tag 112 is an NFC tag, then the gift recipient may use their gift-recipient computing device 116 to scan the NFC tag to retrieve the unique NFC-tag identifier, and a second gift-transfer application 126 may use the unique tag identifier to retrieve the digital gift from the gift-transfer service 118. Alternatively, if the unique identifier is marked on the gift item or on a tag affixed to the gift item, the unique tag identifier may be input by the gift recipient to the gift-transfer application (e.g., mobile application or web application) in order to retrieve the digital gift from the gift-transfer service 118. Having generally described some of the features of this disclosure, each of the components will now be described in greater detail with reference to some of the other figures.

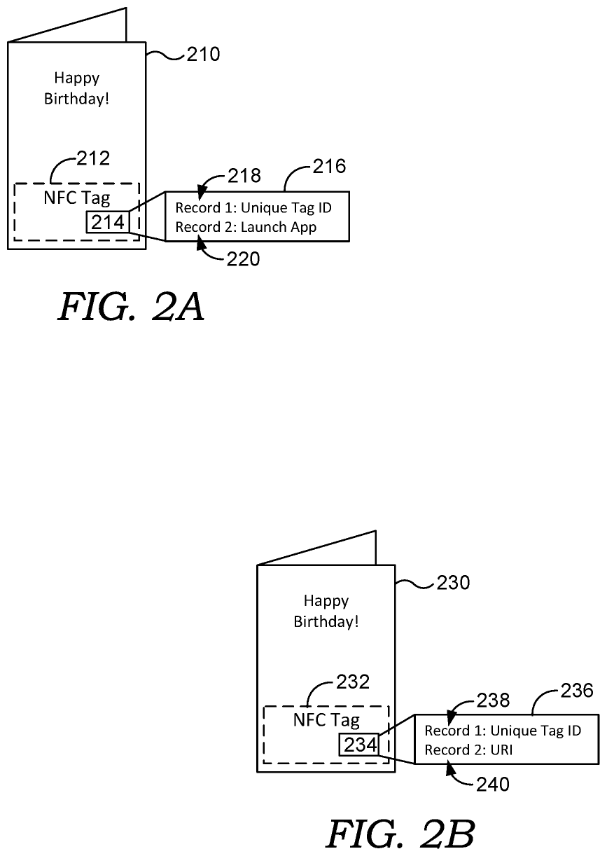

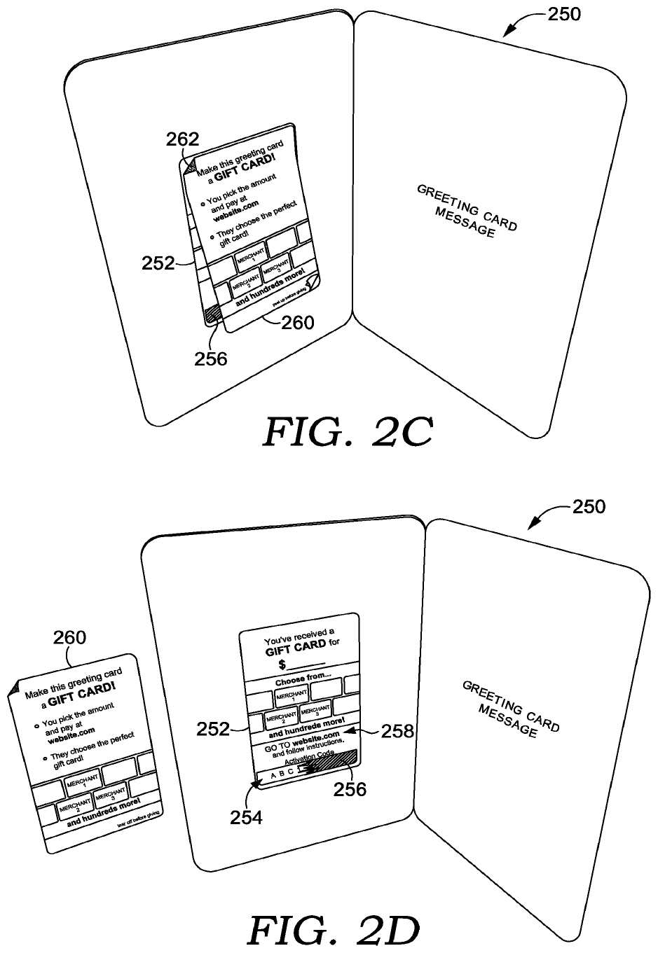

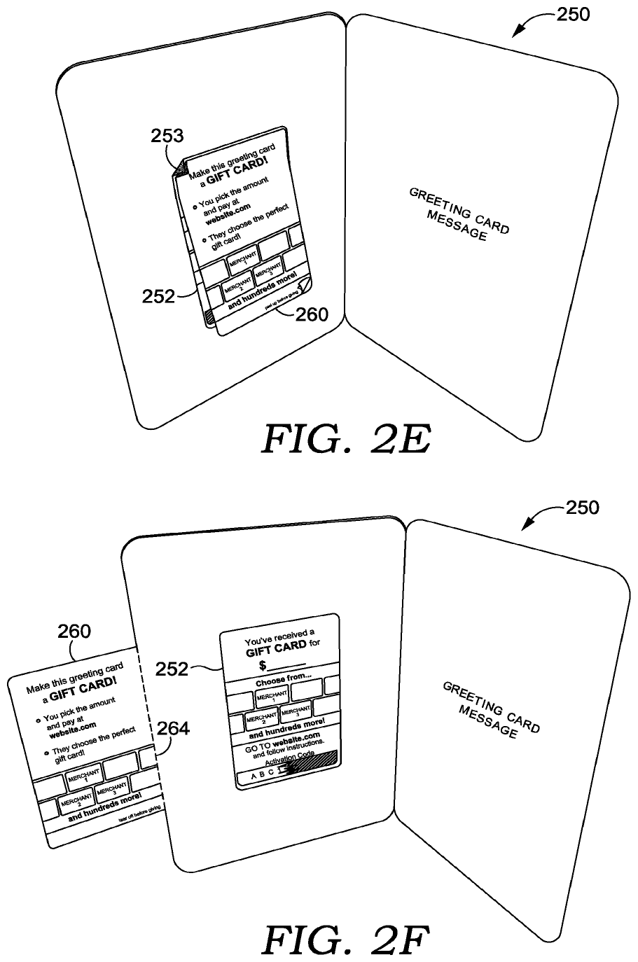

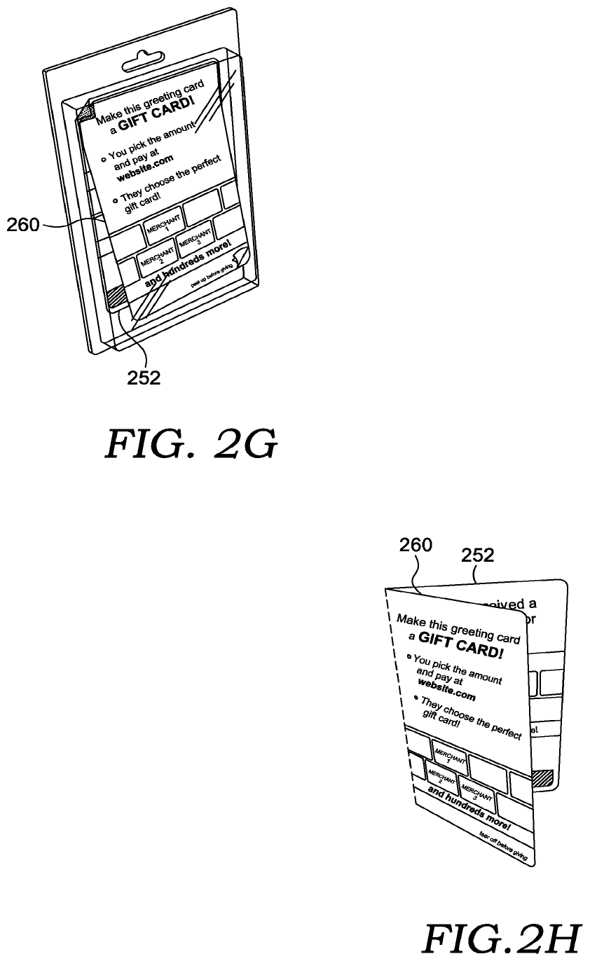

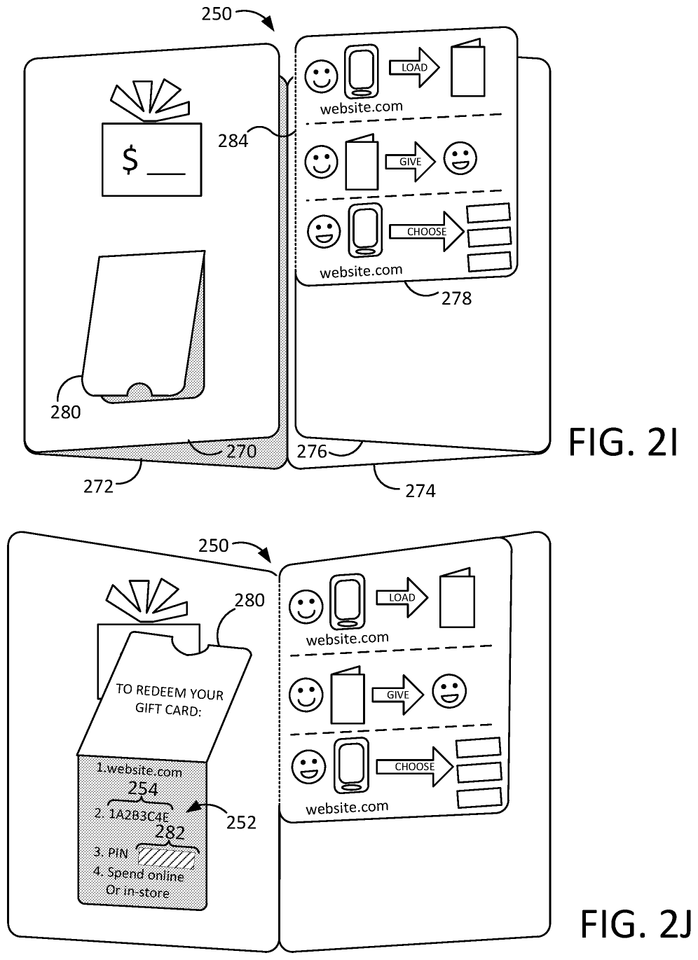

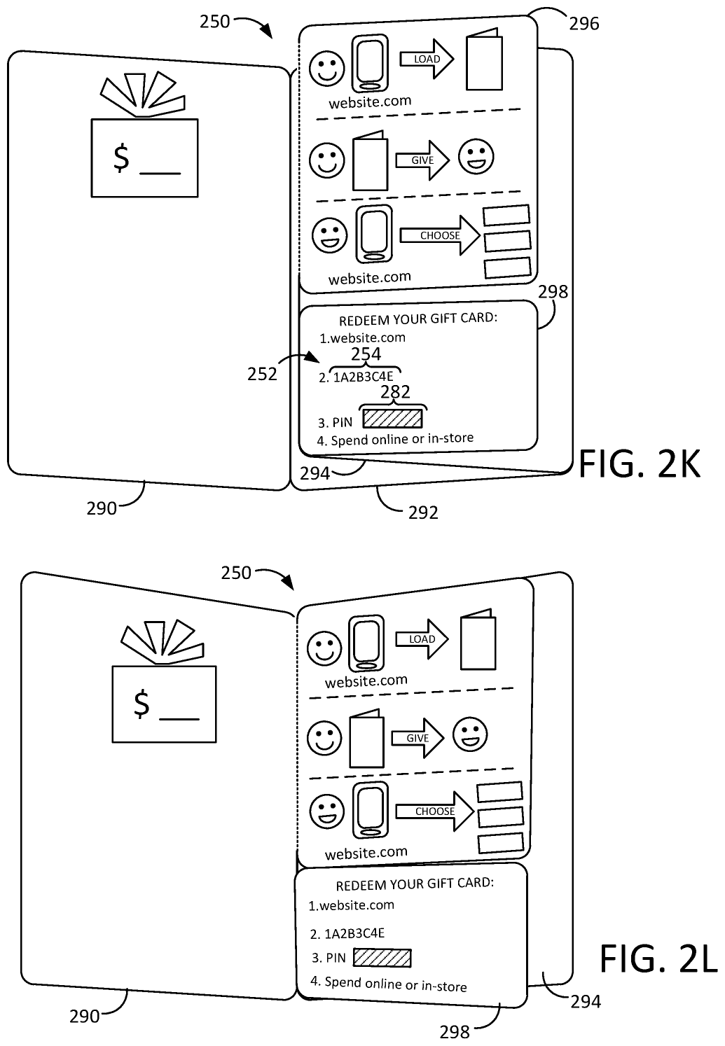

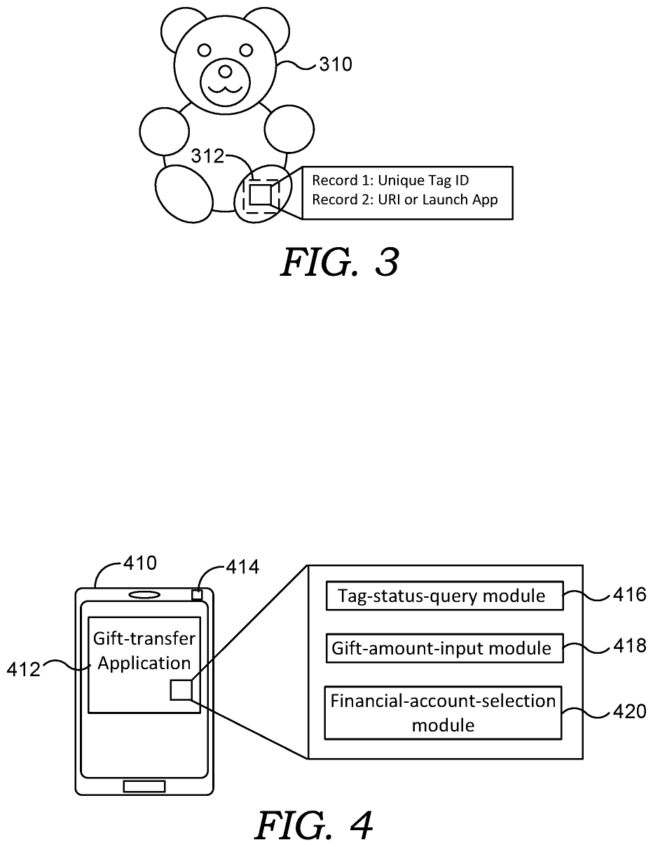

In FIG. 1, the physical gift item 110 is illustratively depicted as a greeting card, and FIGS. 2A and 2B provide two additional illustrative depictions of greeting cards 210 and 230 depicting alternative embodiments of an NFC tag. However, a greeting card is only one example of a physical gift item 110. A physical gift item 110 may include a variety of other hard goods or soft goods that can be constructed to include a tag. For example, FIG. 3 depicts a toy bear 310 with an NFC tag 312 embedded therein, which operates similarly to the NFC tags 112, 212, and 232.

In accordance with an aspect of the disclosure, if the physical gift item 110 is constructed to include an NFC tag, then the NFC tag 112 is encoded to include a unique NFC-tag identifier. In FIG. 2A, the greeting card 210 includes an NFC tag 212 with memory 214, such as a microchip. For example, the NFC tag 212 may be affixed (e.g., adhered, bonded, etc.) to at least one of the panels of the greeting card 210. The memory 214 stores data, and the magnified view 216 illustrates some illustrative stored data. The magnified view 216 includes a first set of stored data 218 that includes a unique NFC-tag identifier that uniquely identifies the NFC tag 212. In addition, the magnified view 216 depicts a second set of stored data 220 that includes computer-executable instructions for opening a gift-transfer application, such as the gift-transfer applications 122 and 126 depicted in FIG. 1. In one aspect of the present disclosure, the second set of stored data 220 includes computer-executable instructions that, when executed by a computing device (e.g., mobile device), open the gift-transfer application. For example, if the gift-transfer application is a mobile application, the computer-executable instructions might trigger an operating system of the computing device to launch or start the gift-transfer application that has been downloaded to the mobile device, as suggested by the text “Launch App” in FIG. 2A. Or, if the gift-transfer application is a mobile application that has not yet been downloaded to the computing device, the computer-executable instructions might trigger the operating system to open a “store” at which the mobile application can be downloaded.

Referring to FIG. 2B, the greeting card 230 also includes an NFC tag 232 with memory 234. Similar to the memory 214 in FIG. 2A, the memory 234 in FIG. 2B also stores a first set of stored data 238 that includes a unique NFC-tag identifier that uniquely identifies the NFC tag 232. In addition, the magnified view 236 depicts a second set of stored data 240 that includes computer-executable instructions for opening a gift-transfer application, such as the gift-transfer applications 122 and 126 depicted in FIG. 1. In one aspect of the present disclosure, the second set of stored data 240 includes computer-executable instructions that, when executed by a computing device (e.g., mobile device), open the gift-transfer application. For example, if the gift-transfer application is a web application, the computer-executable instructions might trigger a browser of the computing device to request a webpage, as suggested by the text “URI” in FIG. 2B.

As generally described above, a tag may alternatively include a marking of a unique identifier directly on a physical gift item or on a sheet of material that is affixed, or can be affixed, to a physical gift item. For example, FIGS. 2C-2F provide illustrative examples of alternative embodiments in which one or more sheets of material may be attached to a greeting card; FIGS. 2G and 2H provide illustrative examples of detached sheets of material that may selectively be affixed to a physical gift item; and FIGS. 2I-2L provide illustrative examples of alternative embodiments in which a unique identifier is marked directly on a greeting card. Each of these figures is described in more detail below.

Referring now to FIGS. 2C-2F an alternative embodiment is depicted in which the physical gift item is a greeting card 250. The greeting card 250 includes at least one tag 252, which includes a sheet of material. The sheet of material may include an adhesive label affixed to a cardstock panel of the greeting card 250. The label may be adhered to the cardstock panel in a manner that allows the label to be removed without damaging the cardstock panel, such as with a low tack, pressure sensitive adhesive. For example, in FIG. 2E a corner of the tag 252 is dog-eared to reveal a deposit 253 of low-tack, pressure-sensitive adhesive and to indicate that the tag 252 in FIG. 2E can be pulled away from the cardstock panel without damage. Alternatively, the label may be adhered to the cardstock panel with a stronger adhesive that is not intended to allow the label to be removed without damaging (e.g., tearing a surface of) the cardstock.

A unique identifier indicia 254 is marked on the tag 252, and the unique identifier indicia 254 includes an identifier that uniquely identifies the tag 252. For example, the illustrated unique identifier indicia 254 includes a series of letters, and in other embodiments, the identifier may include any combination of letter, numbers, symbols, and the like. The tag 252 includes a scratch-off coating 256 layered over the unique identifier indicia 254, and in FIGS. 2D and 2F the coating is illustrated as partially scratched off to reveal the indicia 254. Among other things, the scratch-off coating 256 may provide an indication that someone has already accessed, and become aware of, the unique identifier indicia 254. In an alternative embodiment, the unique identifier indicia 254 may not be obscured by a scratch-off coating or any other type of concealer, such that the unique identifier indicia 254 remains exposed, even before the card 250 is obtained by a gift sender.

The tag 252 may include additional elements. For example, a unique PIN may be marked on the tag 252, the unique PIN being matched to the unique identifier indicia 254. In one embodiment, the unique PIN is obscured by a scratch-off coating or some other concealer that allows the unique PIN to be selectively rendered viewable. As such, the unique identifier indicia 254 may not be obscured or hidden, which would allow a gift sender to associate a gift with the unique identifier, and the unique PIN could remain obscured until the coating or concealer is removed by a gift recipient when retrieving the gift.

In addition, the tag 252 includes instructions 258 for accessing a gift-transfer application, and in the illustrated embodiment, the instructions 258 include a URI (“website.com”). As such, a gift sender or gift recipient may input the URI into a web browser to access the gift-transfer application. In this respect, the tag 252 is very similar to the embodiment illustrated by FIG. 2B, in which the second set of stored data 240 includes computer-executable instructions that, when executed by a computing device (e.g., mobile device), might trigger a browser to request a webpage. In the embodiment of FIG. 2B, inputting the URI to the browser might be executed automatically by the computing device, and in the embodiment of FIGS. 2C-2F, inputting the URI to the browser is executed manually by the gift sender or gift recipient. Once the URI has been input into the browser, the gift-transfer application may present an input field into which the unique tag identifier 254 may be input.

Although FIGS. 2C-2F illustrate an actual website name (“website.com”) marked on the tag 252, a URI might be communicated to a user in various other manners. For example, a phone number might be marked on the tag 252 (or elsewhere on the gift item) with instructions directing the user to text a message (e.g., code) to the phone number, and a hyperlink to the website could be transmitted to the user in reply to their text communication. In yet another embodiment, a QR code could be marked on the tag 252 (or elsewhere on the gift item), and the user could scan the QR code with a computing device (e.g., 114 or 116), which would then launch a browser that navigates to the website.

In another aspect of the disclosure, the card 250 includes another sheet of material 260 that is removably attachable to the card 250 and that includes some instructions for a gift sender to access a gift-transfer application (e.g., “website.com”). For example, the second sheet of material 260 may be removably attached to the card 250 using a low-tack, pressure-sensitive adhesive, and in FIG. 2C a corner of the second sheet 260 is dog-eared to reveal a deposit 262 of low-tack, pressure-sensitive adhesive. To further illustrate this aspect, FIG. 2D depicts the second sheet of material 260 in a detached state so that the tag 252 is not obscured. The second sheet of material 260 may be removably attached in other manners, as well. For example, in FIG. 2F, the sheet of material 260 is attached to the card 250 by a perforated fold line 264, which provides a mechanism by which the second sheet of material 260 may be cleanly and neatly detached or torn away from the card 250. Alternatively, the second sheet of material 260 may be attached to the tag 252 by a perforated fold line.

In one aspect of the disclosure, the second sheet of material provides instructions for a gift sender to open or launch a gift-transfer application. For example, the second sheet of material may instruct a gift sender to input a URI into a browser (e.g., “You pick the amount and pay at website.com”). As such, when the URI is launched in the browser, a web-application version of the gift-transfer application may be launched. As described with respect to the tag 252, the instructions for accessing a web application (i.e., website) might be communicated in various other manners. For example, a phone number might be marked on the second sheet of material 260 (or elsewhere on the gift item) with instructions directing a user to transmit a text message (e.g., code) to the phone number, and a hyperlink to the website could be transmitted to the user in reply to their text message. In yet another embodiment, a QR code could be marked on the second sheet of material 260 (or elsewhere on the gift item), and the user could scan the QR code with a computing device (e.g., 114 or 116), which would then launch a browser that navigates to the website.

In other aspects of the present disclosure, the instructions (e.g., website, phone number, QR code, and the like) for both the gift sender and gift recipient may be provided on a single sheet of material, such that a second sheet of material is omitted. As previously described, the single sheet of material might be constructed with the card in various manners, such as by adhesive label, perforated sheet, additional paper flap, paper insert, and the like.

In FIG. 2E, the tag 252 may be affixed to the card 250 at various stages of the card-preparation process. For example, the tag 252 may be affixed to the card 250 by the card manufacturer, such that the card 250 includes the tag 252 when the card 250 is displayed for sale by a card retailer. Alternatively, the tag 252 may be obtained by a consumer in a detached state in which the tag 252 has not yet been affixed to a physical gift item. For example, FIG. 2G illustrates a separately packaged tag 252 that may be obtained (e.g., purchased) by a gift-sending consumer and affixed to a surface of any card or other physical gift item the consumer selects. As previously described, the tag 252 might be combined with a second sheet of material that provides instructions for accessing the gift-transfer application, or the instructions for gift sending and gift receiving may be provided on a single sheet of material. In the illustrative embodiment of FIG. 2G, the second sheet of material 260 is removably attached by way of a low-tack, pressure-sensitive adhesive, and in FIG. 2H, the second sheet of material 260 is removably attached by way of a perforated tear line. For illustrative purposes, no packaging is included in FIG. 2H.

Referring now to FIGS. 2I-2J alternative embodiments are illustrated in which a tag 252 includes a marking directly on the physical gift item, which includes a greeting card 250. For example, FIGS. 2I and 2J illustratively depict a multi-panel card, which includes a first panel 270, a second panel 272, a third panel 274, a fourth panel 276, and a fifth panel 278. FIG. 2I depicts the panels in a partially opened arrangement in which the first panel 270 is partially opened from the second panel 272, and the fourth panel 276 is partially opened apart from the third panel 274. FIG. 2J shows the panels in a slightly different arrangement, in which the first panel 270 is closed and obscures the second panel 272, and the fourth panel 276 is closed and obscures the third panel 274. The first panel 270 may be affixed (e.g., bonded or adhered) to the second panel 272, and the fourth panel 276 may be affixed to the third panel 274.

In FIGS. 2I-2J, the first panel 270 includes a die-cut flap 280, which may be hingedly opened to reveal a tag 252 printed directly onto the second panel 272. The tag 252 includes a unique tag identifier 254, which is not concealed, and a unique PIN 282, which is concealed by a scratch-off coating. Alternatively, the tag 252 might include the unique tag identifier and omit the unique PIN, as described in other embodiments. Further, the tag 252 might alternatively be printed directly onto the first panel 270. Additional alternative embodiments are also contemplated, and the tag 252 might be marked directly on the second panel 272, and the first panel 270 may be omitted entirely. In operation, and as explained in other portions of this disclosure, the unique tag identifier 254 may be used by a gift sender to associate a digital gift, and the unique PIN 282 could be used by a gift recipient to retrieve the digital gift.

In FIG. 2J, the card 250 also includes the fifth panel 278, which is hingedly coupled to the fourth panel 276 by a perforated fold line 284 to form a paper flap. The fifth panel 278 includes a set of instructions that direct a gift sender through a series of steps to access a gift-transfer application and associate a digital gift with the unique gift identifier. The fifth panel 278 may be selectively detached from the card along the perforated fold line 284, such as after the gift sender has associated a digital gift with the unique identifier 254 and prior to giving the card 250 to the gift recipient. The panel arrangement illustrated in FIGS. 2I and 2J is merely exemplary of one embodiment of the present disclosure, and alternative embodiments may include varied panel arrangements with fewer or more panels the hingedly connect to different sides than those depicted in FIGS. 2I and 2J.

In an alternative embodiment, FIGS. 2K and 2L illustrate another greeting card 250, which includes a first panel 290, a second panel 292, a third panel 294, a fourth panel 296, and a fifth panel 298. FIG. 2K depicts the panels in a partially opened arrangement in which the third panel 294 is partially opened from the second panel 292, and FIG. 2L shows the panels in a slightly different arrangement, in which the third panel 294 is closed and obscures the second panel 292. The third panel 294 may be affixed (e.g., bonded or adhered) to the second panel 292.

The fourth and the fifth panels 296 and 298 each include a flap that hingedly attaches to the third panel 294. The fourth panel 296 is similar to the fifth panel 278 in FIGS. 2I and 2J. The fifth panel 298 includes a tag 252 that is marked directly on the fifth panel 298, and the tag 252 includes a unique tag identifier 254 and a unique PIN 282. The fifth panel 298 is hingedly coupled to the third panel 294 at a fold line to form a paper flap on the inside of the card 250. In FIG. 2K, the fold line that attaches the fifth panel 298 to the third panel 294 is not explicitly perforated. In yet other embodiments, the fold line may be perforated to provide a mechanism by which the fifth panel 298, which includes the tag 252, may be cleanly and neatly detached or torn away from the card 250. For example, a detached fifth panel 298 may fit more easily in a wallet or other storage location than the entire card 250. The panel arrangement illustrated in FIGS. 2K and 2L is merely exemplary of one embodiment of the present disclosure, and alternative embodiments may include varied panel arrangements with fewer or more panels the hingedly connect to different sides than those depicted in FIGS. 2K and 2L.

FIGS. 2C-2L describe various embodiments in which the gift-transfer application is a web application, which is accessed by a browser navigating to a URI. In an alternative embodiment, the gift-transfer application is a mobile application, and the instructions that are provided on the tag 252 and/or on the second sheet of material 260 direct a user to a mobile application (or to an application directory that will allow a user to download a mobile application). Using the mobile application, a user can then input the unique identifier indicia (e.g., 256), as well as a unique PIN if the unique PIN is also marked on the tag 252 or on the second sheet of material 260.

Referring now to FIG. 4, an exemplary computing device 410 is depicted that is running a gift-transfer application 412. The gift-transfer application 412 may be opened as a result of various operations, such as in response to the computing device 410 scanning an NFC tag (e.g., 112, 212, 232) constructed into a physical gift item or in response to a browser navigating to a URI (e.g., when a user inputs a URI into a browser or when a hyperlink is selected). The computing device 410 may be a variety of different types of computing devices. For example, in one aspect the computing device 410 is a mobile device that can scan, and receive a transmission of data from, an NFC tag. Examples of mobile devices include a cellphone or “smart” phone, a tablet computing device, a “smart” watch or other wearable computing device, a laptop, and the like. These examples of mobile devices are provided as context for one environment in which aspects of the disclosure might be practiced or carried out, and the examples are not meant to provide an exhaustive list. Rather, it is understood that aspects of this technology could be practiced or carried out with various other types of computing devices that could scan, and receive a transmission of data from, an NFC tag. In addition, the subject matter of this disclosure may be practiced or carried out with a computing device having a web browser.

In one aspect, the computing device 410 includes an NFC chip 414 configured to receive a transmission of data from an NFC tag (e.g., tags 112, 212, and 232). In addition, the computing device 410 includes the gift-transfer application 412, which includes a software application programmed to perform various functions described in this application. As described in other parts of this disclosure, data that is transmitted from an NFC tag to the computing device may include computer-executable instructions that, when executed by the computing device 410, cause the computing device 410 to launch, open, or start the gift-transfer application 412. And as described in other aspects, the computing device 410 may launch, open, or start the gift-transfer application when a browser navigates to a URI.

The gift-transfer application 412 may be a mobile application or a web application. The gift-transfer application 412 includes various programmed components that are useful to perform operations of the gift-transfer application 412 that facilitate transfer of a digital gift or e-gift. For example, FIG. 4 depicts that the gift-transfer application 412 includes a tag-status-query module 416, a digital-gift-input module 418, and a financial-account-selection module 420. This disclosure may describe the gift-transfer application 412 as having “a copy” or “copies,” which refers to a distinct copy of the gift-transfer application being downloaded to each computing device. Each copy of the gift-transfer application may have the same components, and these components may be used in different manners depending on whether the gift-transfer application is being used to send a digital gift or to receive a digital gift.

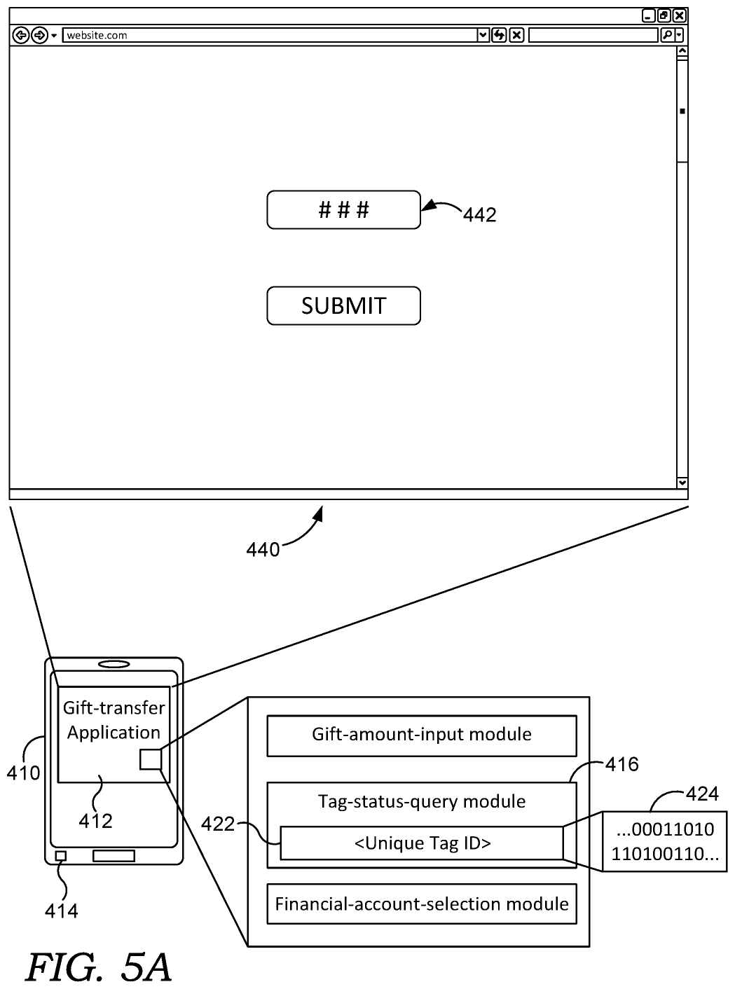

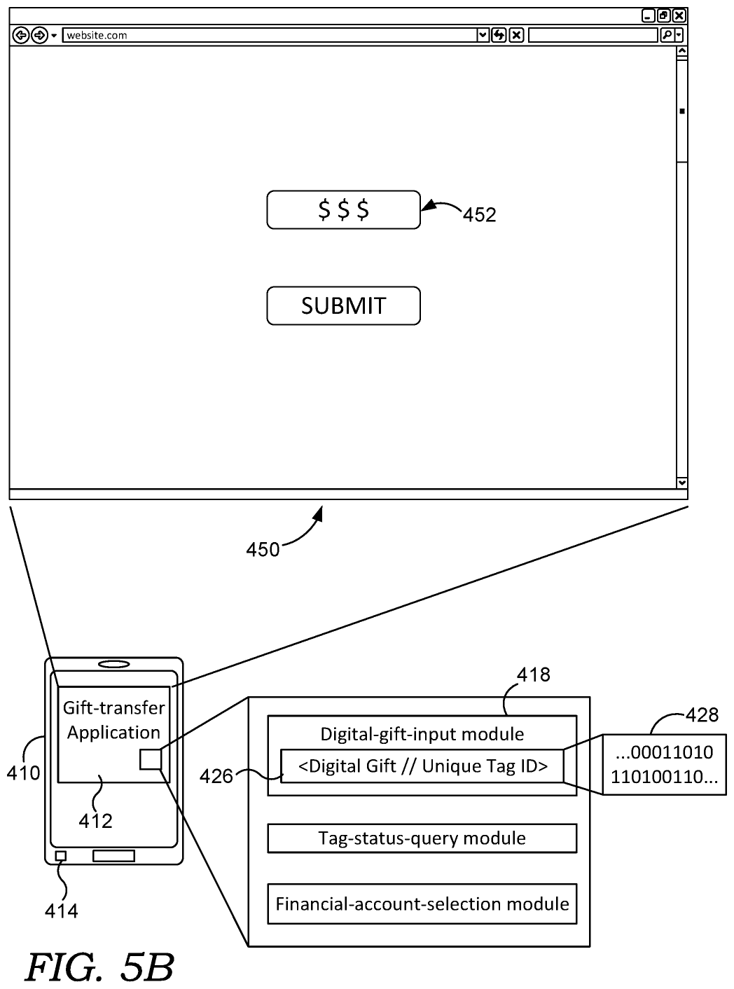

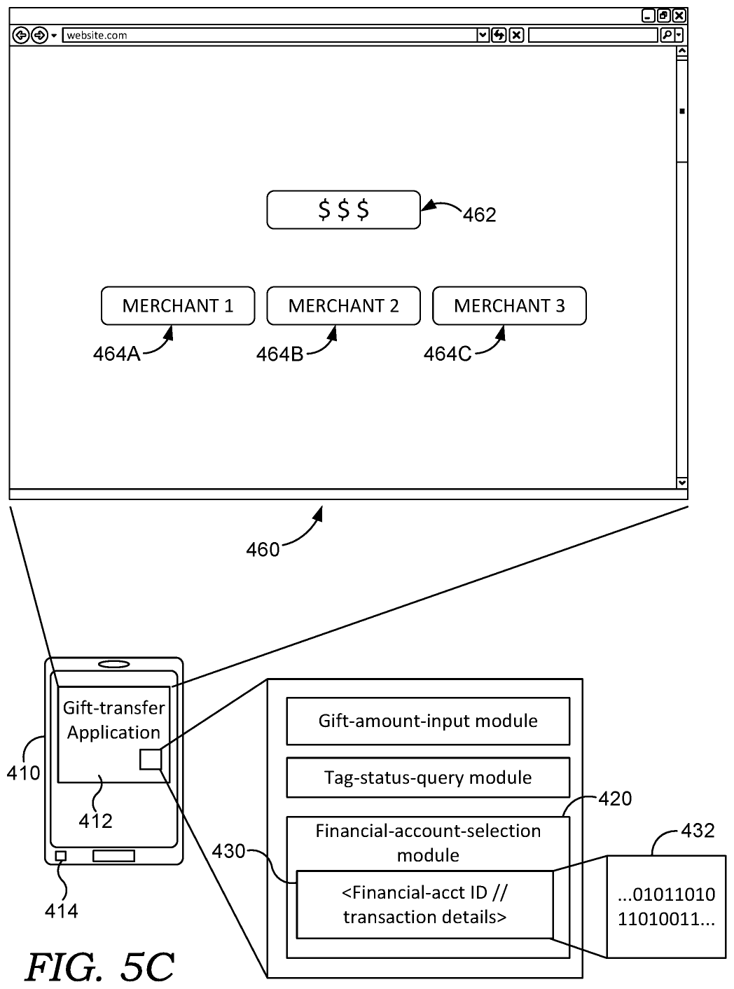

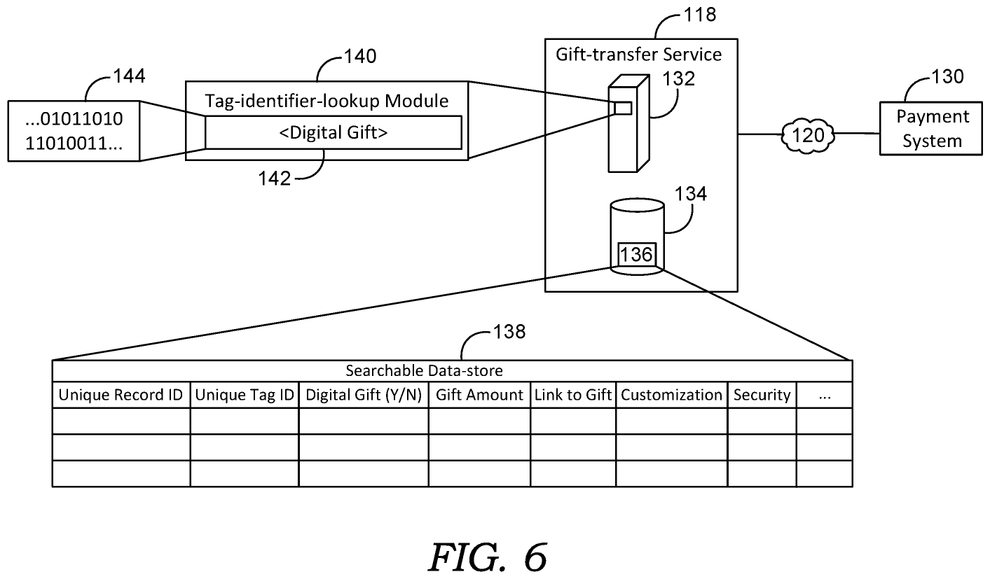

Referring now to FIGS. 5A-5C the tag-status-query module 416, the digital-gift-input module 418, and the financial-account-selection module 420 are depicted with additional details. The tag-status-query module 416 is configured to communicate with the gift-transfer service 118 (see e.g., FIGS. 1 and 6) to determine whether a digital gift has been associated with a unique tag identifier. The tag-status-query module 416 may receive the unique tag identifier in various ways. For example, in some instances, the tag-status-query module 416 receives the unique tag identifier transmitted from the NFC tag constructed into the physical gift item. And in other instances, the tag-status-query module 416 receives the unique tag identifier when a user inputs the unique tag identifier into an input field of a webpage. For example, FIG. 5A depicts an exemplary graphical user interface 440 (GUI) of a web-application, gift-transfer application that may be presented when a user inputs a URI into a browser. As illustrated, the GUI 440 provides an input field 442 into which a user may input a unique tag identifier.

In addition, the tag-status-query module 416 generates or produces a tag-query communication 422 (e.g., interprocess communication) that includes the unique tag identifier and that is transmitted to the gift-transfer service 118. In this sense, the tag-status-query module 416 may generate an electronic communication that did not previously exist, or modify a pre-existing communication, by generating or modifying underlying code 424 that makes up the communication 422.

The tag-status-query module 416 might be invoked by both the gift-transfer application running on the gift-sender mobile device and the gift-transfer application running on the gift-recipient mobile device. For example, by executing the tag-status-query module on the gift-sender mobile device, the gift-transfer application can confirm that no digital gift has been associated with a particular tag (e.g., NFC tag or material-sheet tag) and that the process should proceed with allowing a user to select a digital gift to be associated with the tag. In addition, by executing the tag-status-query module on the gift-recipient mobile device, the gift-transfer application can determine that a digital gift has been associated with a particular tag and can proceed with allowing the gift recipient to receive the digital gift.

The gift-transfer service 118, which maintains a record of unique tag identifiers, can look up the unique tag identifier when the gift-transfer service 118 receives the communication 422. The gift-transfer service 118 can then provide a responsive communication indicating to the gift-transfer application 412 whether the unique tag identifier is associated with a digital gift. Depending on whether a digital gift has been associated with the unique tag identifier, various actions can be taken using the gift-transfer application, such as progressing through a digital-gift selection process or allowing a financial account to be selected to receive a credit of the digital gift.

Referring to FIG. 5B, the gift-transfer application 412 also includes the digital-gift-input module 418, which may be invoked when a determination is made that a digital gift has not been associated with a unique tag identifier. The digital-gift-input module 418 allows a user to input a digital gift that is to be associated with the physical gift item by way of the tag (e.g., NFC tag or material-sheet tag). For example, if the gift-transfer application 412 receives a communication from the gift-transfer service 118 indicating that a digital gift has not been associated with the unique tag identifier, then the digital-gift-input module 418 opens a GUI 450 that allows a digital gift to be selected.

A digital gift can be selected in various manners. In the illustrative depiction of FIG. 5B, the GUI 450 provides an input field 452 into which a user can input a monetary amount. The user may be able to type the amount using a touchscreen keyboard or other type of keyboard. In addition, the mobile device 410 may provide a speech-to-text functionality that allows the user to audibly indicate the monetary amount. In other examples, pre-determined monetary amounts may be presented with selectable buttons (e.g., radio buttons) that allow the user to simply check a box. Other strategies may also be used to allow a monetary amount to be selected or input.

In other examples, the digital-gift-input module 418 may provide a digital-gift online store that allows a user to select a digital gift to be associated with the tag. For example, the digital-gift online store may provide various types of digital media, including videos, images, audio, and the like. In addition, the digital-gift online store may provide the ability to purchase other types of digital gifts, including credits, points, and digital currency.

Once a digital gift has been selected and submitted to the gift-transfer application 412 the digital-gift-input module 418 generates or produces a gift-creating communication 426 (e.g., interprocess communication) that includes the unique tag identifier and an identification of the digital gift. The communication 426 can then be transmitted to the gift-transfer service 118, which may store a record indicating that the unique tag identifier is now associated with a digital gift. As described with respect to the communication 422, the digital-gift-input module 418 may generate an electronic communication that did not previously exist, or modify a pre-existing communication, by generating or modifying underlying code 428 constituting the communication 426. The communication 426 specifies both the unique tag identifier and the digital gift.

Referring now to FIG. 5C, the gift-transfer application 412 also includes the financial-account-selection module 420, which functions as a client-side component of the payment system 130. The financial-account-selection module 420 allows a gift sender to select a financial account to be debited for payment of the digital gift. In addition, the financial-account-selection module 420 allows a gift recipient to select a financial account to be credited when the digital gift includes electronic funds. For example, the gift-transfer service 118 may include its own payment gateway that facilitates payment for the virtual gift. In other examples, the payment system 130 may include a third-party payment system that separately facilitates payment for the digital gift. Examples of third-party payment systems include PayPal®, Samsung® pay, Google® wallet, Apple® pay, and the like. In yet another embodiment, the financial-account-selection module 420 allows a gift recipient to select a merchant gift card to which the electronic funds are to be credited. For example, an e-gift card of a retailer (e.g., Target®, Amazon®, etc.) could be selected by the gift recipient, and the monetary digital gift could be loaded onto the e-gift card. To further illustrate this aspect, an exemplary GUI 460 is depicted in FIG. 5C. The GUI 460 includes a monetary amount field 462 that presents or displays the amount of the monetary gift. In addition, the GUI 460 includes multiple merchant buttons 464A, 464B, and 464C that, when selected, allow the amount of the monetary gift to be loaded onto a gift card of the selected merchant. The financial-account-selection module 420 functions as an interface with the payment system 130 to facilitate debit or credit of funds according to the selection of the digital gift.

Once a financial-account identifier has been input, the financial-account-selection module 420 generates or produces a transaction-details communication 430 (e.g., interprocess communication) that includes an identification of the financial account (e.g., account number) as well as transaction details including the amount to be credited or debited. The communication 430 can then be transmitted to the payment system 130 to execute the transaction. As described with respect to the communications 422 and 426, the financial-account-selection module 420 may generate an electronic communication that did not previously exist, or modify a pre-existing communication, by generating or modifying underlying code 432 constituting the communication 430.

The gift-transfer application 412 may include other components as well that allow additional information to be input and communicated to the gift-transfer system. For example, the gift sender may wish to add a security measure to the gift transfer. As such, the gift-transfer application 412 may provide a security-input component that allows the input of a phone number, security answer, or other information that the gift sender may require before the digital gift can be transferred to the gift-recipient mobile device or account. In addition, the gift-transfer application 412 may allow the gift sender to further customize the gift exchange by adding a customized message, image, song, video, and the like. This additional information can be communicated by the gift-transfer application 412 to the gift-transfer service 118 to be stored in association with the unique tag identifier, such as by using communications similar to communications 422 and 426.

Having described some of the features of the gift-transfer application, reference is now made to FIG. 6 to describe the gift-transfer service 118. As previously mentioned, the gift-transfer service 118 stores information associated with each of the unique tag identifiers and exchanges information with the gift-transfer application in order to help facilitate transfer of the digital gift. As such, the gift-transfer service includes one or more server computing devices 132 coupled to one or more data-storage devices 134. Although only a single object is drawn to illustratively depict the server 132 and the storage device 134, the server 132 may include a plurality of servers and the storage device 134 may include a plurality of storage devices.

Among other things, the one or more server computing devices 132 function to receive communications from the various copies of the gift-transfer application, to update the information associated with each of the unique tag identifiers, and to provide information back to the gift-transfer applications. As such, the gift-transfer service 118 maintains a searchable data-store 136 that stores information 138 in association with each unique tag identifier. For example, the information that is stored in association with each unique tag identifier might include an indication of whether a digital gift has been associated with the unique identifier, a monetary value of the digital gift, a link to the digital gift (if appropriate), security information associated with the digital gift, a unique PIN, customized messaging to be presented with the digital gift, payment information, payment-transaction details, and the like.

As previously described, the gift-transfer service 118 may receive a tag-query interprocess communication (e.g., element 422 in FIG. 5A) from the gift-transfer application 412, the tag-query interprocess communication including a unique tag identifier. The server 132 includes a tag-identifier lookup module 140 configured to receive a search query related to a unique tag identifier and search the data store 136 for data linked to the unique tag identifier. As such, the server 132 may look up the unique tag identifier in the searchable data-store 136 to determine whether a digital gift has been associated with the unique tag identifier. The server 132 may then generate or produce a responsive communication or message that indicates whether the unique tag identifier is associated with a digital gift and that is sent as a reply to the gift-transfer application that sent the query.

The gift-transfer service 118 may receive the tag-query communication in the context of a gift sender initially inputting the tag identifier (e.g., by scanning the NFC tag or inputting the identifier into a web application) or in the context of a gift recipient inputting the tag identifier (e.g., by scanning the NFC tag or inputting the identifier into a web application). If the unique tag identifier has not been associated with a digital gift, then the communication generated by the server 132 may indicate such, in which case the gift-transfer application may proceed through the series of steps that allows a digital gift to be associated with the unique tag identifier using the gift-sender mobile device.

If the unique tag identifier has been associated with a digital gift, then the communication (e.g., gift-notification interprocess communication 142) generated by the server 132 may also include at least some of the additional information stored in association with the unique tag identifier. For example, the communication may also indicate the amount of the digital gift, a copy of the digital gift, a link to the digital gift, a copy of the GUI 460 and any customization details. Or, if the unique tag identifier is associated with security information (e.g., unique PIN), then the communication may request that certain information be verified before the digital gift is transmitted or is allowed to be credited. When generating the gift-notification interprocess communication 142, the tag-identification lookup module 140 may generate an electronic communication that did not previously exist, or modify a pre-existing communication, by generating or modifying underlying code 144 constituting the communication 142.

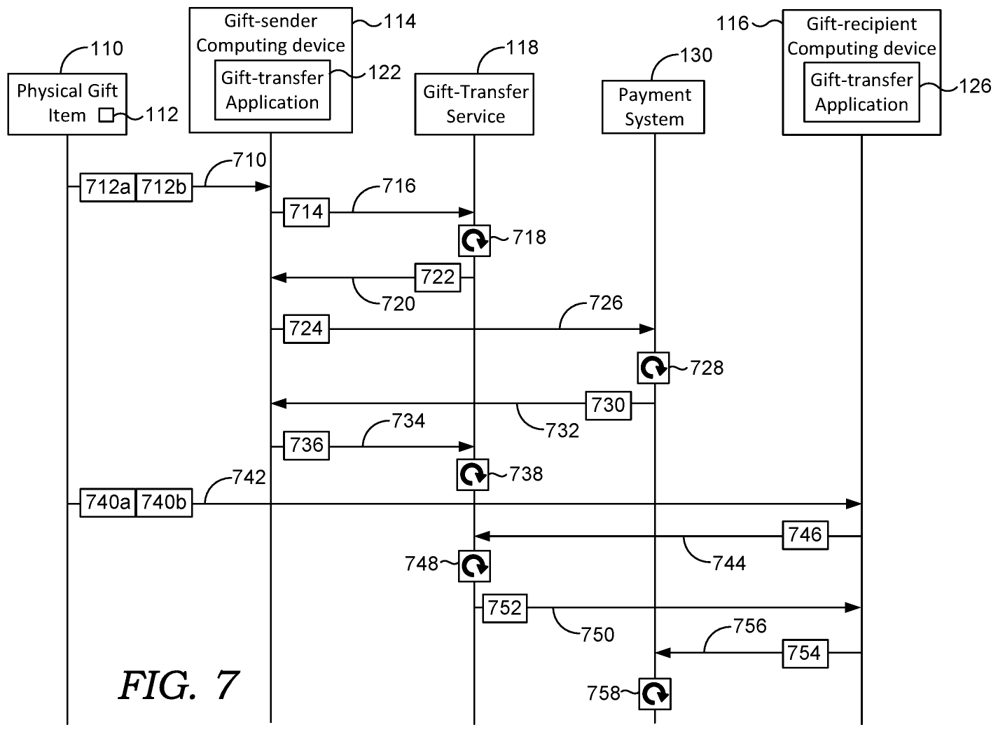

Having described components depicted in FIGS. 1-6, a ping diagram is provided in FIG. 7 to step through some of the operations that might be executed by the physical gift item 110 (including the tag 112), the gift-sender computing device 114 (including a first copy of the gift-transfer application 122), the gift-transfer service 118, the payment system 130, and the gift-recipient computing device 116 (including the second copy of the gift-transfer application 126). When describing FIG. 7, reference may also be made to some or all of the various other figures.

At step 710, a unique tag identifier 712a and computer-executable instructions 712b for opening a gift-transfer application are communicated to the gift-sender mobile device 114. In addition, the gift-sender mobile device 114 opens the first copy of the gift-transfer application 122. For example, an NFC tag 112 may transmit a unique NFC-tag identifier and computer-executable instructions to the gift-sender mobile device 114, or a user may input the unique tag identifier and a URI into a GUI of the gift-transfer application 122. As previously described, if the gift-sender mobile device 114 does not includes a copy of the gift-transfer application, then the instructions 712b may direct the gift-sender mobile device to a downloadable version of the gift-transfer application (e.g., at an online application store or at a web site).

Once open on the gift-sender mobile device 114, the first copy of the gift-transfer application 122 produces a tag-query interprocess communication 714 including the unique tag identifier. The tag-query interprocess communication 714 is transmitted 716 to the gift-transfer service 118, which looks up 718 the unique tag identifier in a searchable data-store (e.g., 136) by executing a tag-identifier lookup module. When the gift-transfer service 118 determines that the unique tag identifier is not associated with a digital gift, the gift-transfer service 118 sends 720 a response communication 722 to the gift-transfer application 122, indicating that the unique tag identifier is not associated with a digital gift.

Using the gift-sender mobile device 114 and the first copy of the gift-transfer application 122, a digital gift may be selected (e.g., input of monetary amount or selection of digital media or digital experience), and a financial account may be selected to provide payment for the digital gift (e.g., by debiting a selected financial account). The first copy of the gift-transfer application produces a transaction-details interprocess communication 724 that includes a financial-account identifier and an amount to be paid for the digital gift, which is transmitted 726 to the payment system 130.

The payment system 130 facilitates 728 payment from the financial account that was selected, and provides 732 payment confirmation 730 to the first copy of the gift-transfer application 122. The first copy of the gift-transfer application 122 may then transmit 734 a gift-creating interprocess communication 736 to the gift-transfer service 118, the gift-creating interprocess communication including at least the unique tag identifier and an identification of the digital gift. The gift-transfer service 118 may then update 738 the information stored in association with the unique tag identifier to indicate that the unique tag identifier is associated with a digital gift. For example, the gift-transfer service 118 may update an existing record that relates to the unique tag identifier, or may create a new searchable entry that links the unique tag identifier to the digital gift.

Although not depicted in the ping diagram of FIG. 7, in an alternative embodiment, a payment confirmation may be provided from the payment system 130 to the gift-transfer service 118. This payment confirmation may be sent in addition to, or in lieu of, sending the payment confirmation to the first copy of the gift-transfer application. In addition, the payment system 130 may also generate and send a gift-creating interprocess to the gift-transfer service 118. These types of operations and communication exchanges might depend on the relationship between the gift-transfer service 118 and the payment system 130, such as whether these two elements are operated by the same entity or operated by different entities.

Referring back to FIG. 7, as previously described, a gift sender may give the physical gift item 110 to a gift recipient. As such, a unique tag identifier 740a and computer-executable instructions 740b for opening a gift-transfer application are communicated to the gift-recipient mobile device 116. In addition, the gift-recipient mobile device 116 opens the second copy of the gift-transfer application 126. For example, using the gift-recipient mobile device 116, the NFC tag 112 may be scanned and the unique tag identifier 740a and computer-executable instructions 740b may be transmitted 742 to the gift-recipient mobile device 116, or a user may input the unique tag identifier and a URI into a GUI of the gift-transfer application 126.

The second copy of the gift-transfer application 126 may then transmit 744 a tag-query communication 746 to the gift-transfer service 118, the tag-query communication 746 including the unique tag identifier. The gift-transfer service 118 may perform a look up function 748 by searching its data store for the unique tag identifier to determine that the unique tag identifier is associated with the digital gift. The gift-transfer service 118 may transmit 750 a gift-notification interprocess communication 752 to the second copy of the gift-transfer application 126, the gift-notification interprocess communication including a description of the digital gift, as well as any information that helps to retrieve the digital gift, such as a link to the payment system, a GUI that allows funds to be loaded onto a merchant gift card, a copy to digital content, a link to 3^{rd}-party digital content, and the like. Using the gift-recipient mobile device 116 and the second copy of the gift-transfer application 126, a financial account may be selected to receive the credit specified by the digital gift. In turn, the second copy of the gift-transfer application 126 may produce a transaction-details interprocess communication 754 that is transmitted 756 to the payment system 130. The payment system 130 can then facilitate credit 758 of the financial account specified in the transaction-details interprocess communication 754.

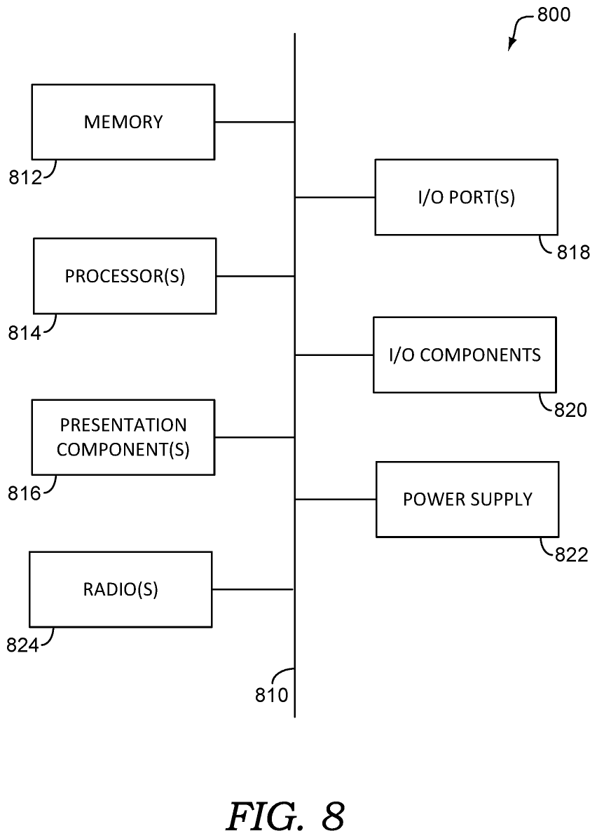

Several of the components described in FIGS. 1-7 include or utilize a computing device. Referring now to FIG. 8, an exemplary operating environment for implementing aspects of the technology described herein is shown and designated generally as a computing device 800. The computing device 800 is but one example of a suitable computing environment and is not intended to suggest any limitation as to the scope of use of the technology described herein. Neither should the computing device 800 be interpreted as having any dependency or requirement relating to any one or combination of components illustrated.

The technology described in this disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 8, the computing device 800 includes a bus 810 that directly or indirectly couples the following devices: memory 812, one or more processors 814, one or more presentation components 816, input/output (I/O) ports 818, I/O components 820, and an illustrative power supply 822. The bus 810 represents what may be one or more busses (such as an address bus, data bus, or a combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Such is the nature of the art, and it is reiterated that the diagram of FIG. 8 is merely illustrative of an exemplary computing device that can be used in connection with one or more aspects of the technology described in this disclosure. Distinction is not necessarily made between such categories as “workstation,” “server,” “laptop,” “handheld device,” etc., as all are contemplated within the scope of FIG. 8 and refer to “computer” or “computing device.”

The computing device 800 typically includes a variety of computer-readable media. Computer-readable media can be any available media that can be accessed by computing device 800 and includes both volatile and nonvolatile, removable and non-removable media. By way of example, and not limitation, computer-readable media may comprise computer storage media and communication media. Computer storage media includes both volatile and nonvolatile, removable and non-removable media implemented for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media is different from computer storage media and typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

The memory 812 includes computer storage media in the form of volatile and/or nonvolatile memory. The memory 812 may be removable, non-removable, or a combination thereof. Exemplary memory includes solid-state memory, hard drives, optical-disc drives, etc. The computing device 800 includes one or more processors 814 that read data from various entities such as the bus 810, the memory 912, or the I/O components 820. The presentation component(s) 816 present data indications to a user or other device. Exemplary presentation components 816 include a display device, speaker, printing component, vibrating component, etc. The I/O ports 818 allow computing device 800 to be logically coupled to other devices, including I/O components 820, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. The computing device may include a radio 824. The radio 824 transmits and receives radio communications. The computing device may be a wireless terminal adapted to receive communications and media over various wireless networks. The computing device 800 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When referring to “short” and “long” types of connections, it is not meant to refer to the spatial relation between two devices. Instead, general reference is made to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection, as well as near-field-communication protocol. A long-range connection may include a connection using one or more of CDMA, GPRS, GSM, TDMA, and 802.16 protocols.

One or more of the computing devices 800 might be used in various capacities in the subject matter described in this disclosure. For example, the mobile computing devices 114, 116, and 410 may include at least some of the components described with respect to the computing device 800. In addition, the server(s) 132, the storage device(s) 134, and the payment system 130 may also include at least some of the components described with respect to the computing device 800. In a further aspect, the various modules (e.g., 416, 418, 420, and 140) may be implemented as a set of computer-readable instructions that utilize a processor to carry out respective operations and to create or modify data, which may be represented by underlying code.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

1. A method for transferring a gift, the method comprising:
receiving by a server computer program a first request communication that includes an identifier unique to a gift item, the first request communication being received from a first client computer program;
executing by the server computer program a first lookup function by searching a data-store to determine that a value stored in the data-store in association with the identifier indicates that an electronic gift is not associated with the identifier;
transmitting by the server computer program a first response communication to the client computer program, the first response communication including a monetary-value field, which is operational to receive an input of a monetary value, and a payment portal operational to charge a financial account an amount equal to the monetary value;
receiving by the server computer program a second request communication that indicates the monetary value;
transforming by the server computer program the data-store to store the monetary value associated with the identifier;
after the data-store has been transformed, receiving by the server computer program a third request communication that includes the identifier unique to the gift item, the third request communication being received from a second client computer program;
executing by the server computer program a second lookup function by searching the data-store to determine that the monetary value is stored in the data-store in association with the identifier; and
transmitting by the server computer program a second response communication to the second client computer program, the second response communication including a plurality of value-allocation links, wherein each value-allocation link included in the plurality of value-allocation links includes a respective option for applying the monetary value to an electronic gift card of a respective merchant.

2. The method of claim 1, wherein the first client computer program and the second client computer program are instances of a web application.

3. The method of claim 1, wherein the second request is received from the client computer program.

4. The method of claim 1, wherein the second request is received from a payment-processing computer program.

5. The method of claim 1, wherein the identifier comprises data associated with a bar code, QR code, or a unique near-field-communication (NFC) tag on or attached to the gift item.

6. The method of claim 1, wherein the third request communication further comprises security input data required by the server computer program before transmitting the second response communication to the second client computer program.

7. The method of claim 1, wherein the second request communication additionally indicates at least one of a customized message, image, song, and video, wherein the method further comprises transforming by the server computer program the data store to store the at least one of the customized message, image, song, and video associated with the identifier.

8. The method of claim 7, wherein the second response communication further includes the at least one of the customized message, image, song, and video associated with the identifier for display on via the second client computer program.

9. A method of transferring a gift, the method comprising:
sending by a client computer program executing a gift-transfer application a first request communication including an identifier unique to a gift item;
receiving by the client computer program a first response communication, the first response communication including a plurality of value-allocation links, wherein each value-allocation link included in the plurality of value-allocation links includes a respective option for applying a monetary value associated with the identifier to an electronic gift card of a respective merchant;
displaying by the client computer device in a graphical user interface a monetary amount field presenting an amount of the monetary value;
receiving an input of a selection of one of the value-allocation links associated with a merchant; and
interfacing with a payment system to facilitate payment of the monetary value to the merchant.

10. The method of claim 9, wherein the identifier comprises data associated with a bar code, a QR code, or a unique near-field-communication (NFC) tag identifier.

11. The method of claim 9, wherein the first request communication further comprises security data input by a user of the client computer program.

12. The method of claim 9, wherein the first response communication further includes at least one of a customized message, image, song, and video associated with the identifier for display in the graphical user interface.

13. The method of claim 9, wherein the gift-transfer application is a web application.

14. The method of claim 9, wherein the first request communication is sent to a server computer program operable to search a data-store for the identifier and the monetary value associated with the identifier.

15. The method of claim 14, wherein the first response communication is received from the server computer program in response to the first request communication.

16. One or more non-transitory computer-readable media having computer-executable instructions embodied thereon that, when executed on one or more processors, perform the following steps:
receiving by a server computer program a first request communication that includes an identifier unique to a gift item, the first request communication being received from a first client computer program;
executing by the server computer program a first lookup function by searching a data-store to determine that a value stored in the data-store in association with the identifier indicates that an electronic gift is not associated with the identifier;
transmitting by the server computer program a first response communication to the client computer program, the first response communication including a monetary-value field, which is operational to receive an input of a monetary value, and a payment portal operational to charge a financial account an amount equal to the monetary value;
receiving by the server computer program a second request communication that indicates the monetary value;
transforming by the server computer program the data-store to store the monetary value associated with the identifier;
after the data-store has been transformed, receiving by the server computer program a third request communication that includes the identifier unique to the gift item, the third request communication being received from a second client computer program;
executing by the server computer program a second lookup function by searching the data-store to determine that the monetary value is stored in the data-store in association with the identifier; and
transmitting by the server computer program a second response communication to the second client computer program, the second response communication including a plurality of value-allocation links, wherein each value-allocation link included in the plurality of value-allocation links includes a respective option for applying the monetary value to an electronic gift card of a respective merchant.

17. The one or more non-transitory computer-readable media of claim 16, wherein the first client computer program and the second client computer program are instances of a web application.

18. The one or more non-transitory computer-readable media of claim 16, wherein the second request is received from the client computer program.

19. The one or more non-transitory computer-readable media of claim 16, wherein the second request is received from a payment-processing computer program.

20. The one or more non-transitory computer-readable media of claim 16, wherein the identifier comprises data associated with a bar code, QR code, or a unique near-field-communication (NFC) tag on or attached to the gift item.
